(19) United States
(12) Patent Application Publication
(10) Pub. No.: US 2010/0191464 A1
(43) Pub. Date: Jul. 29, 2010

(54) ROUTE DISPLAYING METHOD, LOCATED OBJECT DISPLAYING METHOD, AND SYSTEM THEREOF

(76) Inventor: Jinsong He, Hefei City (CN)

Correspondence Address: NORTH AMERICA INTELLECTUAL PROPERTY CORPORATION, P.O. BOX 506, MERRIFIELD, VA, 22116, US

(21) Appl. No.: 12/403,384

(22) Filed: Mar. 13, 2009

(30) Foreign Application Priority Data
Jan. 23, 2009 (CN) 200910003939.2

(51) Int. Cl. G01C 21/36

(52) U.S. Cl. 701/209; 701/200; 701/208

(57) ABSTRACT

A route displaying method, which includes: planning a route from a starting point to a target point; determining if the route goes through a 3-D road having an upper road and a lower road; utilizing a first sign to indicate the route when the route passes through the upper road; and utilizing a second sign to indicate the route when the route passes through the lower road. A located object displaying method under similar concept is also disclosed, which includes: acquiring a location of a located object; acquiring a location of a 3-D road; comparing the two locations to determine if the located object utilizes the 3-D road; utilizing a first sign to indicate the located object when the located object utilizes the upper road; and utilizing a second sign to indicate the located object when the located object utilizes the lower road.

### BACKGROUND OF THE INVENTION

The present invention relates to a route displaying method, a located object displaying method and modules thereof, and particularly relates to a route displaying method and a located object displaying method utilizing different signs while utilizing a 3-D road, and systems thereof.

A navigator such as a GPS system has become more and more popular in recent years. However, there are many more complicated 3-D roads such as a viaduct, a freeway, a bridge or an underpass that are provided in modern cities. One serious problem of this kind of 3-D road is that the 3-D road usually has many branches, for example, a viaduct has an upper road and a lower road, and a user will go to a place far from the target if he/she chooses the wrong branch. Current navigators use a voice guidance to inform a user when he/she is about to enter one branch of a 3-D road, but such a voice guidance is easily lost by or misunderstood by a user, especially in a noisy environment.

Therefore, a new invention is needed to solve above-mentioned problem.

### SUMMARY OF THE INVENTION

One embodiment of the present invention discloses a route displaying method, which includes: planning a route from a starting point to a target point; determining if the route goes through a 3-D road having an upper road and a lower road; utilizing a first sign to indicate the route when the route passes through the upper road; and utilizing a second sign to indicate the route when the route passes through the lower road.

Another embodiment of the present invention discloses a route displaying system corresponding to the above-mentioned route displaying method. The route displaying system includes: a route planning module, for planning a route from a starting point to a target point; a processing unit, for determining if the route goes through a 3-D road having an upper road and a lower road; utilizing a first sign to indicate the route when the route passes through the upper road; and utilizing a second sign to indicate the route when the route passes through the lower road.

Another embodiment of the present invention discloses a located object displaying method, which includes: acquiring a location of a located object; acquiring a location of a 3-D road having an upper road and a lower road; comparing the location of the located object and the location of the 3-D road to determine if the located object utilizes the 3-D road; utilizing a first sign to indicate the located object when the located object utilizes the upper road; and utilizing a second sign to indicate the located object when the located object utilizes the lower road.

Another embodiment of the present invention discloses a located object displaying system corresponding to the above-mentioned located object displaying method. The located object displaying system includes: a location device, for acquiring a location of a located object; a processing unit, for acquiring a location of a 3-D road having an upper road and a lower road; comparing the location of the located object and the location of the 3-D road to determine if the located object utilizes the 3-D road; utilizing a first sign to indicate the located object when the located object utilizes the upper road; and utilizing a second sign to indicate the route when the located object utilizes the lower road.

Via the above-mentioned embodiments, the user utilizing the navigator can easily identify which road of the 3-D road should be utilized, thus the error for choosing a wrong way while utilizing the 3-D road can be avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1˜FIG. 4 are schematic diagrams illustrating a navigating method according to an embodiment of the present invention.

FIG. 5 is a flow chart illustrating steps of a route displaying method included in the navigating method shown in FIG. 1˜FIG. 4.

FIG. 6 is a flow chart illustrating steps of a located object displaying method included in the navigating method shown in FIG. 1˜FIG. 4.

FIG. 7 is a block diagram illustrating a navigator utilizing the navigating method according to an embodiment of the present invention.

### DETAILED DESCRIPTION

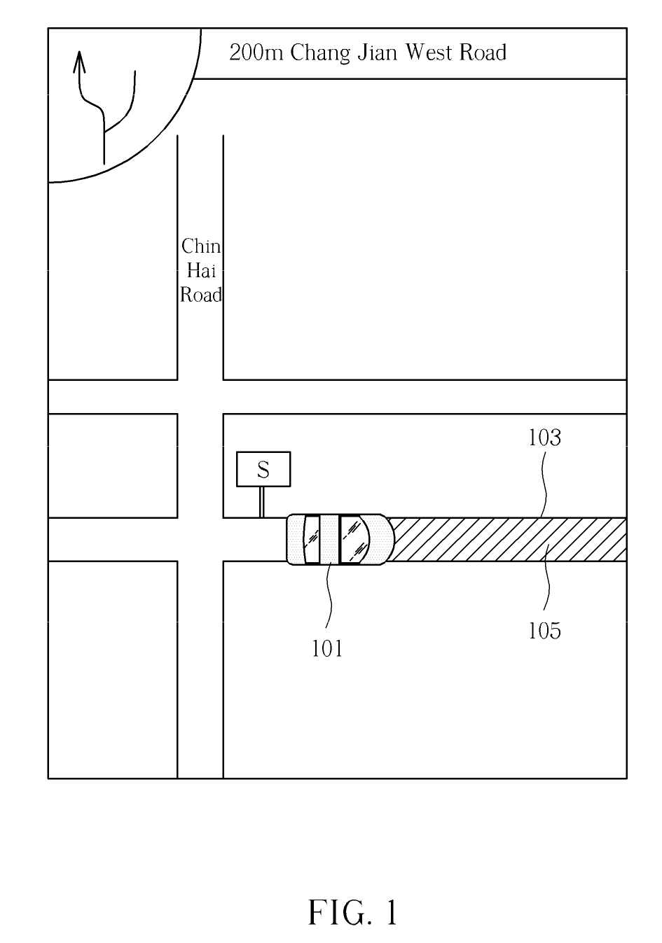

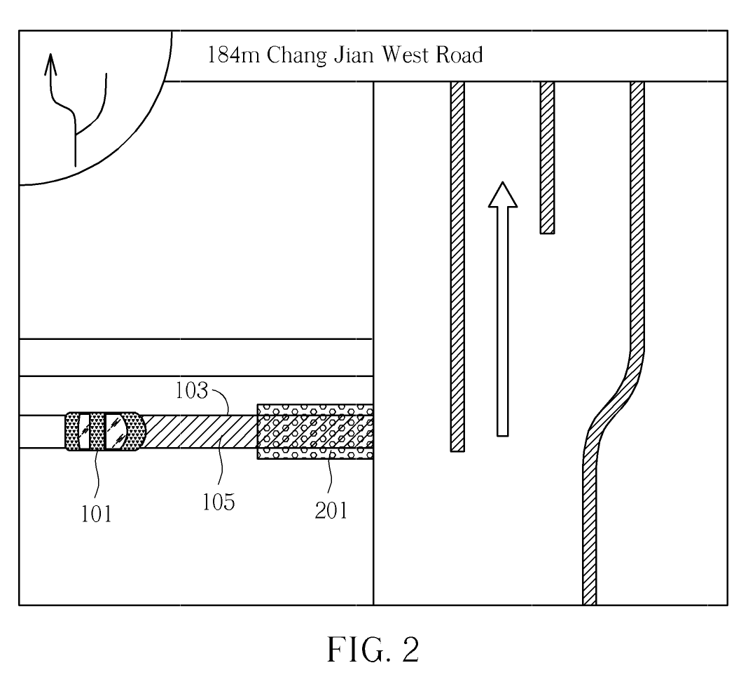

FIG. 1˜FIG. 4 are schematic diagrams illustrating a navigating method according to an embodiment of the present invention, which can be displayed on a screen of a navigator or a location device. In this case, a starting point, a target point and a route between a starting point and a target point are determined, and a target object 101 such as a car will be navigated to the target point. Please refer to FIG. 1, which illustrates a target object 101 moving on a normal road 103, and follows a route 105 to reach a target point. In FIG. 1, the target object 101 has a distance from a 3-D road more than a predetermined value (ex. 500 m). The target object 101 is indicated by a first sign, for example, a car icon with red color that is shown as oblique lines in FIG. 1 and edges with solid lines, and the route 105 is indicated by a solid line.

In FIG. 2, the target object 101 has a distance from a 3-D road less than a predetermined value, that is, the target object 101 is about to enter the 3-D road 201. The target object 101 is indicated by a second sign, for example, a car icon with gray color that is shown as triangles in FIG. 2 and edges with solid lines, and the route 105 is indicated by a solid line if it utilizes the normal road 103, but is indicated by a dotted line (i.e. circles plus oblique lines) if it utilizes a lower road of the 3-D road 201. Additionally, if the route 105 utilizes an upper road of the 3-D road 201, the route 105 is still indicated by a solid line, the same as a normal road, but such a situation is not illustrated in FIG. 2. Please note the reason that an upper road of the 3-D road 201 is drafted to have a wider width than a lower road is just for clearly identifying it. In fact the upper road and the lower road of the 3-D road 201 always have the same width, thus the 3-D road 201 looks the same as the normal road 103, as shown in FIG. 3.

In FIG. 4a, the target object 101 enters the 3-D road 201 and utilizes a lower road. The target object 101 is indicated by a third sign, for example, the body and edges of the target object 101 are drafted in dotted lines, and the route 105 is indicated by a dotted line.

Briefly, the above-mentioned embodiments can be summarized as follows: If the target object moves on a normal road, the embodiments utilize a first sign to indicate the target object and a first sign to indicate a route. If the target object is about to enter a 3-D road, the embodiments utilize a second sign to indicate the target object and a second sign to indicate the route when the route utilizes a lower road of the 3-D road. If the target object enters a lower road of the 3-D road, a third sign is utilized to indicate the target object and a second sign to indicate the route when the route utilizes a lower road of the 3-D road. Please note that the above-mentioned embodiments are only for example and do not mean to limit the scope of the present invention. For example, the route has the same signs for a normal road and an upper road of the 3-D road and a different sign for a lower road of the 3-D road in this case. However, the route can have the same signs for a normal road and a lower road of the 3-D road and a different sign for an upper road of the 3-D road.

Further more, the navigating method according to the present invention is not limited to provide a second sign different from the first sign for a normal road and a third sign for a 3-D road to the target object, when the target object is about to enter the 3-D road. The navigating method according to the present invention can also provide only two different signs to the target object to identify which road (normal road or the 3-D road) the target object utilizes. Such rules can also be applied to the target object. These kinds of variations should also fall in the scope of the present invention.

In FIG. 4b, the target object 101 leaves the 3-D road and re-enters a normal road again. Thus the target object 101 is indicated by the first sign, and the route 105 is indicated by the solid line, the same as FIG. 1.

The navigating method shown in FIG. 1 FIG. 4 can be regarded as being composed of a route displaying method and a located object displaying method. The route displaying method plans a route from a starting point to a target point and indicates the route. The located object displaying method locates the target object and displays the target object and an environment near to it. The detailed steps of these two methods will be described as below. Also, if the located object displaying method includes navigating the target object to the target point, then it becomes a navigating method without displaying a route.

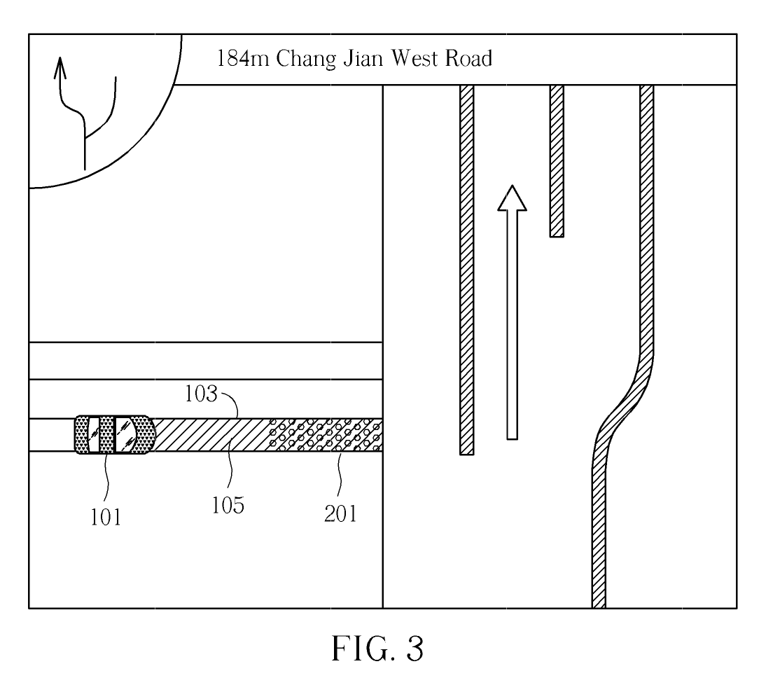

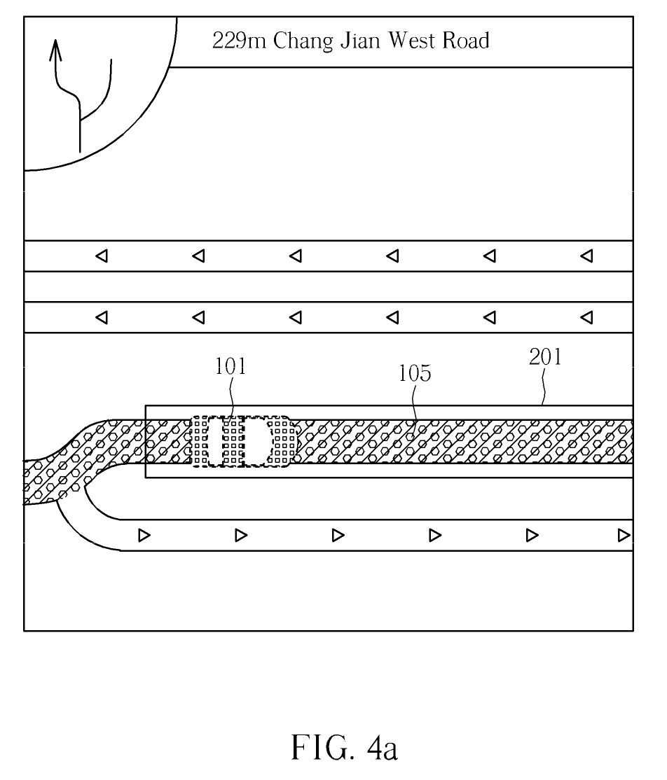

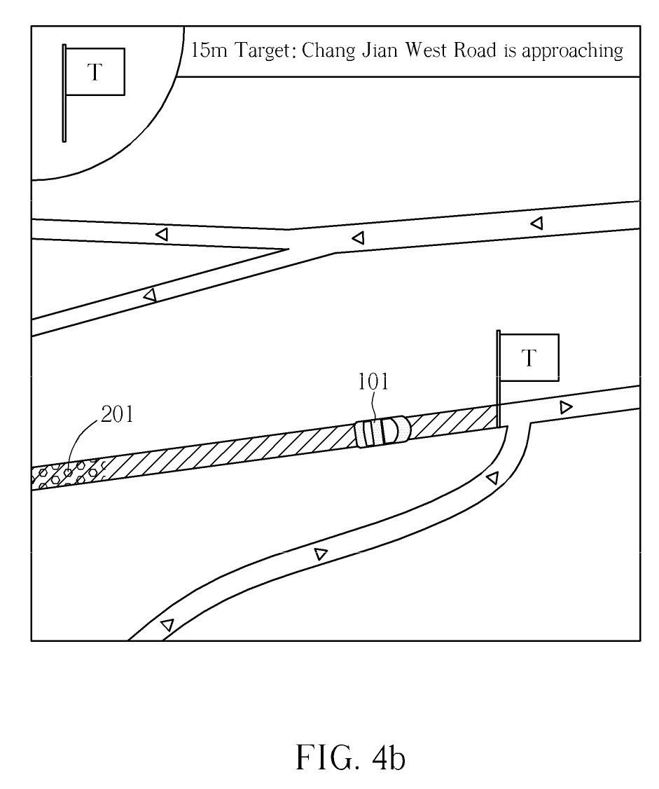

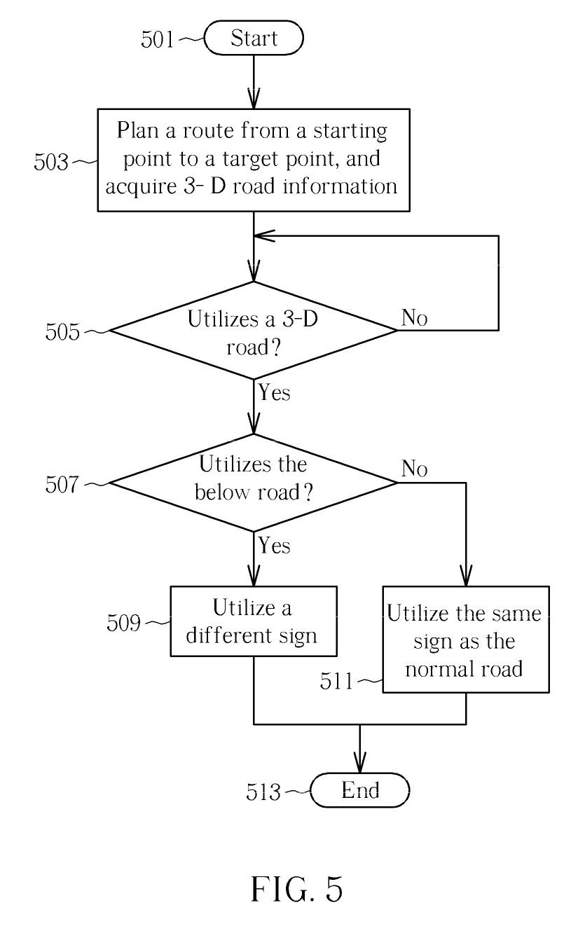

FIG. 5 is a flow chart illustrating steps of a route displaying method included in the navigating method shown in FIG. 1˜FIG. 4. As shown in FIG. 5, the route displaying method includes the steps of:

Step 501

Start.

Step 503

Plan a route from a starting point to a target point, and acquire 3-D road information. The 3-D road information can be stored in a data base. By this way, it can be determined if the route passes through a 3-D road or not. Since the detailed steps of planning a route from a starting point to a target point, and acquiring 3-D road information are known to persons skilled in the art, it is omitted for brevity here.

Step 505

Determine if the route utilizes a 3-D road. If not, keep processing the step 505. If yes, go to step 507.

Step 507

Determine if the route utilizes a lower road. If yes, go to step 509. If not, go to step 511.

Step 509

Utilize a different sign.

Step 511

Utilize the same sign as the normal road.

Step 513

End.

Please note that the route is not limited to having the same signs for a normal road and an upper road of the 3-D road and a different sign for a lower road of the 3-D road. The route can have the same signs for a normal road and a lower road of the 3-D road and a different sign for an upper road of the 3-D road, as above-mentioned. Accordingly, the N and Y after the steps 607 can be exchanged.

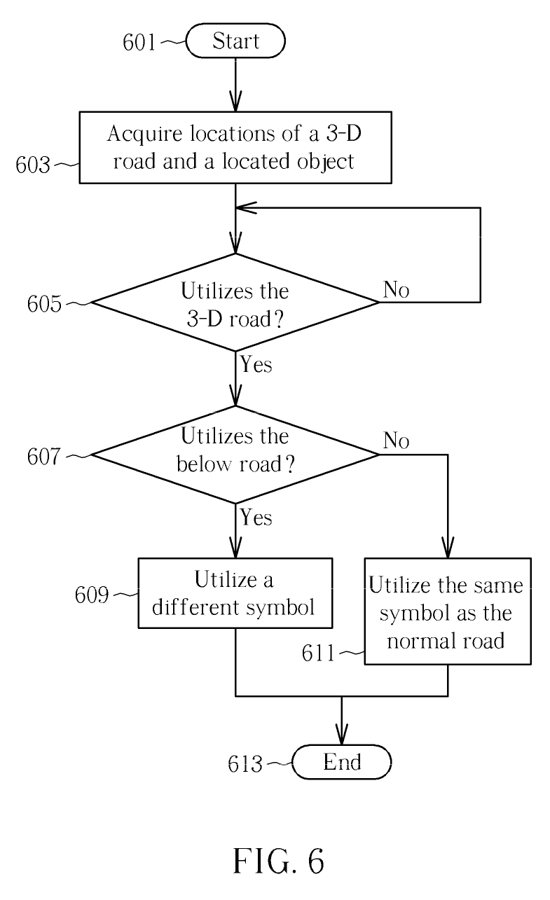

FIG. 6 is a flow chart illustrating steps of a located object displaying method included in the navigating method shown in FIG. 1˜FIG. 4.

Step 601

Start.

Step 603

Acquire locations of a 3-D road and the located object (i.e. the target object which is located). Since the detailed steps of acquiring locations of a 3-D road and the located object are well known to persons skilled in the art, it is omitted for brevity here.

Step 605

Determine if the located object utilizes the 3-D road. If not, keep processing step 605. If yes, go to step 607.

Step 607

Determine if the route utilizes a lower road. If yes, go to step 609. If not, go to step 611.

Step 609

Utilize a different sign.

Step 611

Utilize the same sign as the normal road.

Step 613

End.

Please note that the located object is not limited to having the same signs for a normal road and an upper road of the 3-D road and a different sign for a lower road of the 3-D road. The located object can have the same signs for a normal road and a lower road of the 3-D road and a different sign for an upper road of the 3-D road, as above-mentioned. Accordingly, the N and Y after the step 607 can be reversed.

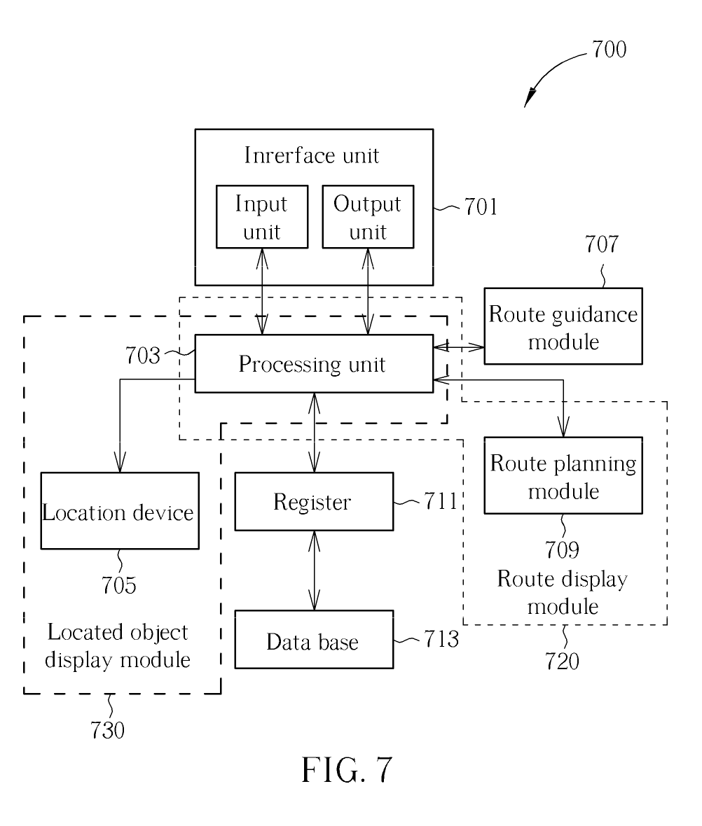

FIG. 7 is a block diagram illustrating a navigator utilizing the navigating method according to an embodiment of the present invention. It should be noted that the navigating method according to embodiments of the present invention is not limited to the system shown in FIG. 7, but also can be applied to other types of navigators. The navigator 700 includes: an interface unit 701, a processing unit 703, a location device 705, a route guidance module 707, a route planning module 709, a register 711, and a data base 713. The interface unit 701 serves to input data to the processing unit 703 or receives the data output from the processing unit 703. The location device 705 serves to locate the location of the target object. The route guidance module 707 serves to navigate the target object to the target point. The route planning module 709 serves to plan a route from a start point to a target point. The processing unit 703 serves to read 3-D road information from the data base 713, via the register 711.

Therefore, for the embodiment shown in FIG. 5, the processing unit 703 reads 3-D road information from the data base 713, and the route guidance module 707 plans the route from the start point to the target point. Also, the processing unit 707 processes the steps 505˜513 shown in FIG. 5. For the embodiment shown in FIG. 6, the processing unit 703 reads 3-D road information from the data base 713, and the location device 705 locates the target object. Also, the processing unit 707 processes the steps 605˜613 shown in FIG. 6. Besides, if the target object is desired to be navigated to the target point, the route planning module 709 is utilized. Briefly, the processing unit 703 and the route planning module 709 can be regarded as a route displaying system 720. Furthermore, the processing unit 703 and the location device 705 can be regarded as a located object displaying system 730.

Via above-mentioned embodiments, the user utilizing the navigator can easily identify which road of the 3-D road should be utilized, thus the error of choosing a wrong way while utilizing the 3-D road can be avoided.

Those skilled in the art will readily observe that numerous modifications and alterations of the device and method may be made while retaining the teachings of the invention.

What is claimed is:

1. A route displaying method, comprising:
planning a route from a starting point to a target point;
determining if the route goes through a 3-D road having at least a upper road and a lower road;
utilizing a first sign to indicate the route when the route passes through the upper road; and
utilizing a second sign to indicate the route when the route passes through the lower road.

2. The route displaying method of claim 1, wherein the 3-D road is one of a viaduct, a freeway, a bridge and an underpass.

3. The route displaying method of claim 1, further comprising utilizing the first sign to indicate the route when the route passes through a normal road.

4. The route displaying method of claim 1, further comprising utilizing the second sign to indicate the route when the route passes through a normal road.

5. A located object displaying method, comprising
acquiring a location of a located object;
acquiring a location of a 3-D road having at least a upper road and a lower road;
comparing the location of the located object and the location of the 3-D road to determine if the located object utilizes the 3-D road;
utilizing a first sign to indicate the located object when the located object utilizes the upper road; and
utilizing a second sign to indicate the located object when the located object utilizes the lower road.

6. The located object displaying method of claim 5, further comprising:
utilizing a third sign to indicate the located object while the located object is utilizing a normal road but is about to utilize the 3-D road.

7. The located object displaying method of claim 5, wherein the 3-D road is one of a viaduct, a freeway, a bridge and an underpass.

8. The located object displaying method of claim 5, further comprising: utilizing the first sign to indicate the located object when the located object utilizes a normal road.

9. The located object displaying method of claim 5, further comprising utilizing the second sign to indicate the located object when the located object utilizes a normal road.

10. The located object displaying method of claim 5, further comprising:
providing a starting point and a target point of the located object;
planning a route from the starting point to the target point;
utilizing a first sign to indicate the route when the located object utilizes the upper road; and
utilizing a second sign to indicate the route when the located object utilizes the lower road.

11. A route displaying system, comprising:
a route planning module, for planning a route from a starting point to a target point;
a processing unit, for determining if the route goes through a 3-D road having an upper road and a lower road; for utilizing a first sign to indicate the route when the route passes through the upper road; and utilizing a second sign to indicate the route when the route passes through the lower road.

12. The route displaying system of claim 11, wherein the 3-D road is one of a viaduct, a freeway, a bridge and an underpass.

13. The route displaying system of claim 11, wherein the processing unit further utilizes the first sign to indicate the route when the route passes through a normal road.

14. The route displaying system of claim 11, wherein the processing unit further utilizes the second sign to indicate the route when the route passes through a normal road.

15. A located object displaying system, comprising:
a location device, for acquiring a location of a located object;
a processing unit, for acquiring a location of a 3-D road having an upper road and a lower road; comparing the location of the located object and the location of the 3-D road to determine if the located object utilizes the 3-D road; utilizing a first sign to indicate the located object when the located object utilizes the upper road; and utilizing a second sign to indicate the route when the located object utilizes the lower road.

16. The located object displaying system of claim 15, the processing unit further utilizes a third sign to indicate the located object while the located object is utilizing a normal road but is about to utilize the 3-D road.

17. The located object displaying system of claim 15, wherein the 3-D road is one of a viaduct, a freeway, a bridge and an underpass.

18. The located object displaying system of claim 15, the processing unit further utilizes the first sign to indicate the located object when the located object utilizes a normal road.

19. The located object displaying system of claim 15, the processing unit further utilizes the second sign to indicate the located object when the located object utilizes a normal road.

20. The located object displaying system of claim 15, further comprising:
a route guidance module, for planning a route from a starting point to a target point;
wherein the processing unit utilizes a first sign to indicate the route when the located object utilizes the upper road and utilizes a second sign to indicate the route when the located object utilizes the lower road.
